(19) United States
(12) Patent Application Publication
(10) Pub. No.: US 2014/0057166 A1
(43) Pub. Date: Feb. 27, 2014

(54) COMPOSITE GRAPHITE PARTICLES AND USE THEREOF

(71) Applicant: Showa Denko KK, Minato-ku,Tokyo (JP)

(72) Inventors: Yoshihito Yokoyama, Minato-ku (JP); Chiaki Sotowa, Minato-ku (JP); Masataka Takeuchu, Minato-ku (JP)

(73) Assignee: SHOWA DENKO K.K., Minato-ku, Tokyo (JP)

(21) Appl. No.: 13/985,611

(22) PCT Filed: Dec. 7, 2012
(86) PCT No.: PCT/JP2012/007847

§ 371 Date: Aug. 15, 2013

(30) Foreign Application Priority Data
Dec. 9, 2011 (JP) 2011-270731
Dec. 9, 2011 (JP) 2011-270732

(51) Int. Cl. H01M 4/587; H01M 10/0525; H01M 4/133

(52) U.S. Cl. CPC H01M 4/587; H01M 4/133; H01M 10/0525
USPC 429/211; 429/231.8; 427/113; 252/182.1

(57) ABSTRACT

Provided are Composite graphite particles comprising core material comprising graphite obtained by heat treating petroleum based coke with a grindability index of 35 to 60 at a temperature of not less than 2500° C. and not more than 3500° C. and carbonaceous layer present on the surface of the core material, wherein the composite graphite particles have an intensity ratio I_{D}/I_{G} of 0.1 or more in intensity (I_{D}) of peak in the range between 1300 and 1400 cm⁻¹ and intensity (I_{G}) of peak in the range between 1500 and 1620 cm⁻¹ as measured by Raman spectroscopy spectrum, the composite graphite particles have a 50% particle diameter (D₅₀) of not less than 3 μm and not more than 30 μm in accumulated particle size distribution by volume as measured by the laser diffraction method, and the composite graphite particles have a ratio I₁₁₀/I₀₀₄ of 0.2 or more in an intensity of 110 diffraction peak (I₁₁₀) and an intensity of 004 diffraction peak (I₀₀₄) as measured by the X ray wide angle diffraction method when the composite graphite particles and a binder was molded with pressure to adjust the density of 1.35 to 1.45 g/cm³.

### TECHNICAL FIELD

The present invention relates to composite graphite particles and use thereof. More specifically, the present invention relates to composite graphite particles useful for negative electrode material which can provide a lithium ion battery having low electric resistance and good cycle characteristic during low current charge and discharge, or a lithium ion battery having low electric resistance, good input-output characteristic, and high current cycle characteristic; and manufacturing method thereof. The present invention also relates to an electrode sheet and a lithium ion battery in which the composite graphite particles are used.

### BACKGROUND ART

Lithium ion battery is used as power supply for portable electric device or the like. At first, the lithium ion battery had many problems such as insufficient battery capacity and short charge-discharge cycle life. To date, these problems have been overcome one by one, and the applications for the lithium ion battery have expanded to light electrical devices such as cellular phone, notebook computer, and digital camera, and high power electrical devices which need more power such as electric power tool and battery assisted bicycle. Further, in particular, the lithium ion battery is expected to be used as a power source for an automobile. Research and development of electrode material, cell structure or the like has been extensively conducted.

As negative electrode material for lithium ion battery, carbon based material and metal based material are under development.

Carbon based materials include a carbon material having high crystallinity such as graphite and a carbon material having low crystallinity such as amorphous carbon. These can be used for negative electrode active material since the intercalation and deintercalation reaction of lithium ion is possible for each of these.

It is known that a battery obtained using carbon material having low crystallinity has high capacity, but cycle deterioration is significant. On the other hand, it is known that a battery obtained using carbon material having high crystallinity has relatively low resistance and stable cycle characteristic, but battery capacity is low.

In an attempt to mutually compensate the disadvantages of the low crystallinity carbon material and the high crystallinity carbon material, a composite of the low crystallinity carbon material and the high crystallinity carbon material has been proposed.

For example, Patent Document 1 discloses a technology in which a surface of natural graphite is coated with amorphous carbon by mixing natural graphite with pitch, and then performing heat treatment at 900 to 1100° C. under an inert gas atmosphere.

Patent Document 2 discloses a technology in which core material consisting of carbon material is immersed in tar or pitch, which is then dried or heat treated at 900 to 1300° C.

Patent Document 3 discloses a technology in which carbon precursor such as pitch is mixed with graphite particles obtained by granulating natural graphite or flaky artificial graphite so as to be on the surface of the graphite particles, and calcination is performed in the temperature range between 700 and 2800° C. under an inert gas atmosphere.

Further, Patent Document 4 discloses composite graphite particles used as negative electrode active material, the composite graphite particles obtained by coating spherical graphite particles with carbonized product of resin such as phenol resin, the spherical graphite particles being obtained by granulating scaly graphite having d₀₀₂ of 0.3356 nm, R value of 0.07 and Lc of 50 nm into spherical shape by mechanical force.
Patent Document 1: JP 2005-285633 A
Patent Document 2: JP 2976299 B
Patent Document 3: JP 3193342 B
Patent Document 4: JP 2004-210634 A

### SUMMARY OF THE INVENTION

### Problems to be Resolved by the Invention

The technologies as described above have been proposed. Nonetheless, further improvements remain demanded for battery capacity, initial coulomb efficiency, cycle characteristic during low current charge and discharge, input-output characteristic, high current cycle characteristic, electric resistance or the like in lithium ion battery.

An object of the present invention is to provide composite graphite particles useful for negative electrode material which can provide a lithium ion battery having good cycle characteristic during low current charge and discharge, or a lithium ion battery having good input-output characteristic and high current cycle characteristic, and a manufacturing method thereof. Another object is to provide an electrode sheet and a lithium ion battery in which the composite graphite particles are used.

### Means for Solving the Problems

That is, the present invention encompasses the followings.

[1] Composite graphite particles comprising core material comprising graphite obtained by heat treating petroleum based coke with a grindability index of 35 to 60 at a temperature of not less than 2500° C. and not more than 3500° C. and
carbonaceous layer present on the surface of the core material,
wherein the composite graphite particles have an intensity ratio I_{D}/I_{G} of 0.1 or more in intensity (I_{D}) of peak in the range between 1300 and 1400 cm⁻¹ and intensity (I_{G}) of peak in the range between 1500 and 1620 cm⁻¹ as measured by Raman spectroscopy spectrum, the composite graphite particles have a 50% particle diameter (D₅₀) of not less than 3 μm and not more than 30 μm in accumulated particle size distribution by volume as measured by the laser diffraction method, and the composite graphite particles have a ratio I₁₁₀/I₀₀₄ of 0.2 or more in an intensity of 110 diffraction peak (I₁₀₀) and an intensity of 004 diffraction peak (I₀₀₄) as measured by the X ray wide angle diffraction method when the composite graphite particles and a binder was molded with pressure to adjust the density of 1.35 to 1.45 g/cm³.
[2] The composite graphite particles according to claim 1, wherein d₀₀₂ based on 002 diffraction peak as measured by the X ray wide angle diffraction method is not less than 0.334 nm and not more than 0.342 nm.
[3] The composite graphite particles according to [1] or [2], wherein a BET specific surface area based on nitrogen adsorption is 0.2 to 30 m²/g.
[4] The composite graphite particles according to any one of [1] to [3], wherein an amount of the carbonaceous layer is 0.05 to 10 parts by mass relative to 100 parts by mass of the core material.
[5] The composite graphite particles according to any one of [1] to [4], wherein the carbonaceous layer is obtained by heat treating organic compound at a temperature of 500° C. or higher.
[6] The composite graphite particles according to [5], wherein the organic compound is at least one compound selected from the group consisting of petroleum based pitch, coal based pitch, phenol resin, polyvinyl alcohol resin, furan resin, cellulose resin, polystyrene resin, polyimide resin and epoxy resin.
[7] The composite graphite particles according to any one of [1] to [6], wherein the 50% particle diameter (D₅₀) in accumulated particle size distribution by volume as measured by the laser diffraction method is not less than 3 μm and less than 10 μm.
[8] The composite graphite particles according to any one of [1] to [6], wherein the 50% particle diameter (D₅₀) in accumulated particle size distribution by volume as measured by the laser diffraction method is not less than 10 μm and not more than 30 μm.
[9] A method of manufacturing the composite graphite particles according to any one of [1] to [8], the method comprising:
heat treating petroleum based coke having a grindability index of 35 to 60 at a temperature of not less than 2500° C. and not more than 3500° C. to obtain core material comprising graphite,
allowing organic compound to adhere with the core material comprising graphite, and then heat treating at a temperature of 500° C. or higher.
[10] A slurry or a paste comprising the composite graphite particles according to any one of [1] to [8], binder and solvent.
[11] The slurry or the paste according to [10], further comprising natural graphite.
[12] An electrode sheet comprising a laminated layer having a current collector and an electrode layer comprising the composite graphite particles according to any one of [1] to [8].
[13] The electrode sheet according to [12], wherein the electrode layer further comprises natural graphite, and the electrode sheet has a ratio I₁₁₀/I₀₀₄ of not less than 0.1 and not more than 0.15 in an intensity of 110 diffraction peak (I₁₁₀) and an intensity of 004 diffraction peak (I₀₀₄) as measured by the X ray wide angle diffraction method.
[14] A lithium ion battery comprising a negative electrode, in which the negative electrode comprises the electrode sheet according to [12] or [13].

### Advantageous Effects of the Invention

The composite graphite particles according to the present invention are useful as negative electrode active material for lithium ion battery since it has high acceptance of lithium ions. A lithium ion battery obtained using the composite graphite particles is good in low current cycle characteristic, input-output characteristic, high current cycle characteristic or the like.

### EMBODIMENTS FOR CARRYING OUT THE INVENTION

(Composite Graphite Particles)

Composite graphite particles in a preferred embodiment according to the present invention have core material comprising graphite and carbonaceous layer present on the surface of the core material.

The graphite which constitutes the core material is artificial graphite obtained by heat treatment (graphitization) of petroleum based coke.

The petroleum based coke used as a raw material is usually 35 to 60, preferably 37 to 55, more preferably 40 to 50 in a grindability index, i.e., HGI (see ASTM D409). Using of the petroleum based coke having HGI being in the above range can provide a lithium ion battery being excellent in input-output characteristic, low current cycle characteristic, high current cycle characteristic or the like.

HGI can be measured by the following method. A sample having a particle size of 1.18 to 600 μm are prepared, and 50 g of the sample is placed in a Hardgrove grinding test machine. The machine is stopped after rotated for 60 rounds at 5 to 20 rpm. The processed sample is subjected to a 75 μm screen for a total of 3 times: for 10 minutes, for 5 minutes and for 5 minutes (a total of 20 minutes). Then, the mass W [g] of a material passed through the screen was measured to calculate HGI using the following formula.

HGI=13+6.93W

Treatment temperature for graphitization of petroleum based coke is usually not less than 2500° C. and not more than 3500° C., preferably not less than 2500° C. and not more than 3300° C., and more preferably not less than 2550° C. and not more than 3300° C. In a case where the treatment temperature is less than 2500° C., the discharge capacity of the resulting lithium ion battery is decreased. The graphitization treatment is preferably performed under an inert atmosphere. There is no particular limitation for the duration of the graphitization treatment, which may be appropriately selected depending on a throughput, a type of a graphitization furnace or the like. The duration of the graphitization treatment is, for example, about 10 minutes to 100 hours. The graphitization treatment also can be performed, for example, using an Atchison graphitization furnace or the like.

The core material is preferably not less than 3 μm and not more than 30 μm in a 50% particle diameter (D₅₀). The 50% particle diameter (D₅₀) of the core material is preferably not less than 10 μm and not more than 30 μm, more preferably not less than 10 μm and not more than 20 μm in view of obtaining a lithium ion battery being excellent in low current cycle characteristic and high current cycle characteristic. Further, the 50% particle diameter (D₅₀) of the core material is preferably less than 10 μm, more preferably not less than 3 μm and less than 10 μm, more preferably not less than 3.5 μm and not more than 8 μm, even more preferably not less than 4 μm and not more than 7 μm in view of obtaining a lithium ion battery being excellent in input-output characteristic and high current cycle characteristic. Adjustment to the above 50% particle diameter (D₅₀) can be performed by mechanochemical methods such as hybridization, known granulation methods, grinding, sorting or the like. The 50% particle diameter (D₅₀) herein is computed based on accumulated particle size distribution by volume as measured by the laser diffraction method.

The intensity ratio I_{D}/I_{G} (R value) of intensity (I_{D}) of peak in the range between 1300 and 1400 cm₋₁ and intensity (I_{D}) of peak in the range between 1500 and 1620 cm⁻¹ as measured by a Raman spectroscopy spectrum is preferably 0.2 or less, more preferably 0.175 or less, even more preferably 0.15 or less, and most preferably 0.1 or less. R value of the core material is a value measured in a state before the carbonaceous layer is provided on the surface of the core material.

The carbonaceous layer which constitutes composite graphite particles is preferably 0.2 or more, more preferably 0.35 or more, even more preferably 0.5 or more in an intensity ratio I_{D}/I_{G} (R value) of intensity (I_{D}) of peak in the range between 1300 and 1400 cm⁻¹ and intensity (I_{G}) of peak in the range between 1500 and 1620 cm⁻¹ as measured by a Raman spectroscopy spectrum. The upper limit of the intensity ratio I_{D}/I_{G} (R value) is preferably 1.5, more preferably 1. A carbonaceous layer having a larger R value allows easy intercalation and deintercalation of lithium ions between the graphite layers, and improves the high rate charge performance of lithium ion battery. Note that a larger R value means lower crystallinity. The R value of a carbonaceous layer is a value obtained by performing the same method as the following method of forming a carbonaceous layer in the absence of a core material to obtain a carbonaceous material, and measuring the carbonaceous material. The measurement of the R value was performed with a JASCO NRS-5100 under the following conditions: an argon laser beam irradiated with a wavelength of 532 nm and an output power of 7.4 mW; and Raman scattering light was measured with a spectrometer.

In order to allow the presence of a carbonaceous layer on the surface of the core material comprising graphite, organic compound is first adhered to the core material. There is no particular limitation for a method of adhering. The examples of the method include a method in which core material and organic compound are dry-mixed to allow adherence, a method in which solution of organic compound and core material are mixed, and then the solvent is removed to allow adherence or the like. Among these, the method of dry-mixing is preferred. Dry-mixing can be performed, for example, with a mixing combined device equipped with an impeller or the like.

For organic compound to be adhered, isotropic pitch, anisotropic pitch or resin, as well as resin precursor or monomer is preferred. Examples of pitch include petroleum based pitch and coal based pitch, and either isotropic pitch or anisotropic pitch can be used. For the organic compound, resin obtained by polymerizing resin precursor or monomer is preferably used. Preferred resins include at least one selected from the group consisting of phenol resin, polyvinyl alcohol resin, furan resin, cellulose resin, polystyrene resin, polyimide resin and epoxy resin.

Subsequently, the organic compound adhered to the core material is preferably heat treated at preferably 500° C. or higher, more preferably not less than 500° C. and not more than 2000° C., even more preferably not less than 500° C. and not more than 1500° C., and in particular preferably not less than 900° C. and not more than 1200° C. The organic compound is carbonized by the heat treatment to form a carbonaceous layer. The carbonization in the temperature range will provide sufficient adhesion of the carbonaceous layer to the core material, leading to a good balance of battery characteristic, charge characteristic or the like.

The carbonization by heat treatment is preferably performed under a non-oxidizing atmosphere. Non-oxidizing atmospheres include atmospheres which are filled with an inert gas such as argon gas and nitrogen gas. The duration of the heat treatment for carbonization may be appropriately selected depending on manufacturing scale. For example, it is 30 to 120 minutes, preferably 45 to 90 minutes.

In a preferred embodiment, there is no particular limitation for a proportion of the core material and the carbonaceous layer which constitute the composite graphite particles, but the amount of the carbonaceous layer is preferably 0.05 to 10 parts by mass, more preferably 0.1 to 7 parts by mass relative to 100 parts by mass of the core material. In a case where the amount of the carbonaceous layer is too small, improvement effect in cycle characteristic or the like tends to be small. In a case where it is too large, battery capacity tends to be decreased. Note that the amount of the carbonaceous layer can be calculated to be an amount of the organic compound adhered to the core material because the amount of the carbonaceous layer is almost same as that of the organic compound adhered to the core material.

Crushing and grinding are preferably performed after the carbonization treatment. The composite graphite particles obtained by the carbonization treatment may be fused to form a lump, which can be finely granulated by crushing and grinding. The composite graphite particles in an embodiment according to the present invention usually have a 50% particle diameter (D₅₀) in accumulated particle size distribution by volume as measured by the laser diffraction method of not less than 3 μm and not more than 30 μm.

The composite graphite particles in a preferred embodiment according to the present invention have a 50% particle diameter (D₅₀) in accumulated particle size distribution by volume as measured by the laser diffraction method of usually not less than 10 μm and not more than 30 μm, preferably not less than 10 μm and not more than 20 μm in view of low current cycle characteristic and high current cycle characteristic. Further, the composite graphite particles in a preferred embodiment according to the present invention have a 90% particle diameter (D₉₀) in accumulated particle size distribution by volume as measured by the laser diffraction method of preferably not less than 20 μm and not more than 40 μm, more preferably not less than 24 μm and not more than 30 μm in view of low current cycle characteristic and high current cycle characteristic. Further, the composite graphite particles in a preferred embodiment according to the present invention have a 10% particle diameter (D₁₀) in accumulated particle size distribution by volume as measured by the laser diffraction method of preferably not less than 1 μm and not more than 10 μm, more preferably not less than 4 μm and not more than 6 μm in view of low current cycle characteristic and high current cycle characteristic.

The composite graphite particles in a preferred embodiment according to the present invention usually have a 50% particle diameter (D₅₀) in accumulated particle size distribution by volume as measured by the laser diffraction method of not less than 3 μm and not more than 10 μm, preferably not less than 3 μm and less than 10 μm, more preferably not less than 3.5 μm and less than 10 μm, even more preferably not less than 3.5 μm and not more than 8 μm, and most preferably not less than 4 μm and not more than 7 μm in view of input-output characteristic and high current cycle characteristic. The composite graphite particles in a preferred embodiment according to the present invention have a 90% particle diameter (D₉₀) in accumulated particle size distribution by volume as measured by the laser diffraction method of preferably not less than 6 μm and not more than 20 μm, more preferably not less than 8 μm and not more than 15 μm in view of input-output characteristic and high current cycle characteristic. Further, the composite graphite particles in a preferred embodiment according to the present invention have a 10% particle diameter (D₁₀) in accumulated particle size distribution by volume as measured by the laser diffraction method of preferably not less than 0.1 μm and not more than 5 μm, more preferably not less than 1 μm and not more than 3 μm in view of input-output characteristic and high current cycle characteristic.

Note that measured values of the 50% particle diameter of the composite graphite particles and the 50% particle diameter of the core material show almost no difference because the thickness of the carbonaceous layer is in the order of tens of nanometers.

Further, the composite graphite particles in a preferred embodiment according to the present invention have a d₀₀₂ based on a 002 diffraction peak as measured by the X ray wide angle diffraction method of preferably not less than 0.334 nm and not more than 0.342 nm, more preferably not less than 0.334 nm and not more than 0.338 nm, even more preferably not less than 0.3355 nm and not more than 0.3369 nm, and in particular preferably not less than 0.3355 nm and not more than 0.3368 nm.

The composite graphite particles in a preferred embodiment according to the present invention have a crystallite size Lc in the c axial direction of preferably not less than 50 nm, more preferably 75 to 150 nm.

Note that d₀₀₂ and Lc were computed in accordance with JIS R7651 by placing the powder of composite graphite particles in a powder X-ray diffractometer (RIGAKU CORPORATION, Smart Lab IV) and measuring diffraction peaks at the CuKα ray with output power of 30 kV and 200 mA.

The composite graphite particles in a preferred embodiment according to the present invention usually have an intensity ratio I_{D}/I_{G} of intensity (I_{D}) of peak in the range between 1300 and 1400 cm⁻¹ as measured by a Raman spectroscopy spectrum and intensity (I_{D}) of peak in the range between 1500 and 1620 cm⁻¹ of not less than 0.1, preferably 0.1 to 1, more preferably 0.5 to 1, and even more preferably 0.7 to 0.95.

BET specific surface area of the composite graphite particles is preferably 0.2 to 30 m²/g, more preferably 0.3 to 10 m²/g, even more preferably 0.4 to 5 m²/g.

A molded product having a density of 1.35 to 1.45 g/cm³ obtained by pressure molding the composite graphite particles in a preferred embodiment according to the present invention with binder usually has a ratio I₁₁₀/I₀₀₄ of intensity of 110 diffraction peak (I₁₁₀) and intensity of 004 diffraction peak (I₀₀₄) of 0.2 or more, preferably 0.3 or more, more preferably 0.4 or more, and even more preferably 0.5 or more as measured by the X ray wide angle diffraction method. Note that in the measurements, poly(vinylidene fluoride) was used as the binder. Other measurement conditions are the same as described in Examples. A larger value of the intensity ratio I₁₁₀/I₀₀₄ shows that crystal orientation is lower. In a case where this intensity ratio is too small, a charge characteristic tends to be decreased.

### (Slurry or Paste)

The slurry or paste in a preferred embodiment according to the present invention comprises the composite graphite particles, binder and solvent. The slurry or paste in a more preferred embodiment according to the present invention further comprises natural graphite. The slurry or paste is obtained by kneading the composite graphite particles, binder and solvent, and in addition, preferably natural graphite. The slurry or paste can be fabricated in a form such as sheet, pellet or the like, if desired. The slurry or paste in a preferred embodiment according to the present invention is suitably used to manufacture electrode, in particular negative electrode for battery.

Examples of the binder include polyethylene, polypropylene, ethylene-propylene terpolymer, butadiene rubber, styrene-butadiene rubber, butyl rubber, high molecular weight compound having large ionic conductivity or the like. Examples of high molecular weight compound having large ionic conductivity include poly(vinylidene fluoride), polyethylene oxide, polyepichlorohydrin, polyphosphazene, polyacrylonitrile or the like. For a mixing ratio of the composite graphite particles and the binder, 0.5 to 20 parts by mass of the binder is preferably used relative to 100 parts by mass of the composite graphite particles.

In a case where the composite graphite particles and natural graphite are used in combination in the slurry or paste, there is no particular limitation for an amount of natural graphite as long as the intensity ratio I₁₁₀/I₀₀₄ of the electrode sheet described below falls in the following range. Specifically, the amount of natural graphite is preferably 10 to 500 parts by mass relative to 100 parts by mass of the composite graphite particles. Use of natural graphite can provide a battery having a good balance of high current input-output characteristic and cycle characteristic.

Further, the natural graphite is preferably spherical. There is no particular limitation for the particle diameter of the natural graphite as long as the intensity ratio I₁₁₀/T₀₀₄ of the electrode sheet described below falls in the range described below. Specifically, the natural graphite preferably has a 50% particle diameter (D₅₀) in accumulated particle size distribution by volume of 1 to 40 μm. Adjustment of D₅₀ to the above range can be performed by mechanochemical methods such as hybridization, known granulation methods, grinding, sorting or the like.

For example, Chinese natural graphite having D₅₀ of 7 μm is charged into hybridizer NHS1 made from NARA MACHINERY CO., LTD., and processed at a rotor peripheral velocity of 60 m/s for 3 minutes to obtain spherical natural graphite particles having D₅₀ of 15 μm. A slurry or paste can be obtained by mixing 50 parts by mass of the spherical natural graphite particles obtained in this way and 50 parts by mass of the composite graphite particles obtained in an embodiments of the present invention, adding a binder to the mixture and kneading.

There is no particular limitation for solvent, and examples of them include N-methyl-2-pyrrolidone, dimethylformamide, isopropanol, water or the like. In the case of binder which uses water as solvent, thickener is preferably used in combination. The amount of solvent is adjusted so that the viscosity is suitable for applying on a current collector. The slurry or paste in a preferred embodiment according to the present invention may further comprise an electrical conductivity imparting agent. Examples of the electrical conductivity imparting agent include fibrous carbon such as carbon fiber by the gas phase method and carbon nanotube; electrically conductive carbon such as acetylene black and Ketjen Black (Product name).

### (Electrode Sheet)

The electrode sheet in a preferred embodiment according to the present invention comprises a layered product having a current collector and an electrode layer comprising the composite graphite particles according to the present invention. Preferably, the electrode layer further comprises natural graphite. The electrode sheet can be obtained, for example, by applying the slurry or paste according to the present invention on a current collector, drying, and performing pressure molding.

Examples of the current collector include foils, meshes or the like comprising aluminum, nickel, copper or the like. An electrically conductive layer may be provided on a surface of the current collector. The electrically conductive layer usually comprises an electrical conductivity imparting agent and a binder.

There is no particular limitation for a method of applying the slurry or paste. A coating thickness (after dried) of the slurry or paste is usually 50 to 200 μm. In a case where the coating thickness is too large, a standardized battery housing may not be able to accommodate the negative electrode.

Pressure molding methods include molding methods such as rolling pressurization and stamping pressurization. The pressure for pressure molding is preferably about 100 MPa to about 300 MPa (about 1 to 3 t/cm²). The negative electrode obtained in this way is suitable for lithium ion battery.

Further, in a case where the electrode layer comprises a combination of composite graphite particles and natural graphite, the electrode sheet has a ratio I₁₁₀/I₀₀₄ of intensity of 110 diffraction peak (I₁₁₀) and intensity of 004 diffraction peak (I₀₀₄) of preferably not less than 0.1 and not more than 0.15 as measured by the X ray wide angle diffraction method. The intensity ratio I₁₁₀/I₀₀₄ of the electrode sheet using natural graphite can be controlled by adjusting a ratio of the natural graphite particles and the composite graphite particles according to the present invention, and a particle diameter of the natural graphite particles.

### (Lithium Ion Battery (Lithium Secondary Battery))

The lithium ion battery in a preferred embodiment according to the present invention comprises the electrode sheet according to the present invention as negative electrode. For positive electrode of the lithium ion battery in a preferred embodiment according to the present invention, a conventional electrode used for lithium ion battery can be used. Active materials used for positive electrode include, for example, LiNiO₂, LiCoO₂, LiMn₂O₄ or the like.

There is no particular limitation for an electrolyte used in a lithium ion battery. For example, they can include so-called non-aqueous electrolytes in which lithium salts such as LiClO₄, LiPF₆, LiAsF₆, LiBF₄, LiSO₃CF₃, CH₂SO₂Li and CF₃SO₃Li are dissolved in non-aqueous solvents such as, for example, ethylene carbonate, diethyl carbonate, dimethyl carbonate, methylethyl carbonate, propylene carbonate, butylene carbonate, acetonitrile, propionitrile, dimethoxyethane, tetrahydrofuran and γ-butyrolactone; and so-called non-aqueous polymer electrolytes in a solid or gel state.

Further, to an electrolyte, preferably added is a small amount of an additive which shows a decomposition reaction when a lithium ion battery is initially charged. Examples of the additive include vinylene carbonate, biphenyl, propanesulfone or the like. The additive amount of 0.01 to 5% by mass is preferred.

A separator can be provided between a positive electrode and a negative electrode in the lithium ion battery of a preferred embodiment according to the present invention. Examples of the separator include nonwoven fabric, cloth or microporous film made from polyolefine such as polyethylene, polypropylene or the like as main component; or combinations thereof.

### EXAMPLES

Now, the present invention will be described in detail using Examples and Comparative Examples. However, the present invention shall not be limited to these Examples. Note that graphite characteristics, negative electrode characteristics and battery characteristics were measured and evaluated by the following methods.

### (1) Specific Surface Area

It was calculated by the BET method based on the measurement of an amount of nitrogen adsorption.

### (2) Particle Diameter

Two microspatulas of a sample and 2 drops of nonionic surfactant (Triton X) were added to 50 ml of water, and dispersed by sonication for 3 minutes. The resulting dispersion liquid was placed in a laser diffraction particle size distribution measuring system (SEISHIN ENTERPRISE CO., LTD., LMS-2000S) to measure particle size distribution by volume. D₁₀, D₅₀ and D₉₀ were computed from the measured value.

### (3) Grindability Index (HGI)

A sample sized to a particle diameter of 1.18 to 600 μm in an amount of 50 g was placed in a Hardgrove grinding test machine. The machine was stopped after rotated for 60 rounds at 5 to 20 rpm. The processed sample was subjected to a 75 μm screen a total of 3 times: for 10 minutes, 5 minutes and 5 minutes (for 20 minutes in total). The weight W [g] of a material passed through the screen was measured. Grindability index was computed by the following formula.

HGI=13+6.93W

(4) d₀₀₂

X ray diffraction peaks were measured with a powder X-ray diffractometer (RIGAKU CORPORATION, Smart Lab IV) at the CuKα ray with an output power of 30 kV and 200 mA. From the 002 diffraction peak, d₀₀₂ was measured in accordance with JIS R7651.

### (5) I₁₁₀/I₁₀₄

To the graphite particles, 1% by mass aqueous carboxymethylcellulose was added by a small portion with kneading to give a solid content of 1.5% by mass. To this, 1.5% by mass of poly (vinylidene fluoride) (KUREHA CORPORATION, KF polymer V#9300) was added as binder, and further kneaded. Pure water was further added so that sufficient fluidity was obtained, and kneading was performed for 5 minutes at 500 rpm using a defoaming kneader (NISSEI CORPORATION, NBK-1) to obtain paste. The paste was applied on a current collector using an automatic coater and a doctor blade with a clearance of 250 μm. The current collector to which the paste was applied was placed on a hot plate at about 80° C. to remove moisture. Then, it was dried in a vacuum dryer at 120° C. for 6 hours. After drying, pressure molding was performed by uniaxial press so that the electrode density calculated from the total mass and volume of the graphite particles and the binder became 1.40±0.05 g/cm3 to obtain an electrode sheet.

The resulting electrode sheet was cut out in an appropriate size, and pasted on a glass cell for XRD measurements to measure wide angle X ray diffraction peaks. The ratio I₁₁₀/I₀₀₄ of intensity of 004 diffraction peak and intensity of 110 diffraction peak was computed.

### (6) I_{D}/I_{G} (the R Value)

An argon laser beam with a wavelength of 532 nm and an output power of 7.4 mW was irradiated against a graphite sample using a JASCO NRS-5100 to measure Raman scattering light with a spectrometer. From a measured Raman spectroscopy spectrum, the intensity ratio I_{D}/I_{G} of intensity (I_{D}) of peak in the range between 1300 and 1400 cm⁻¹ and intensity (I_{G}) of peak in the range between 1500 and 1620 cm⁻¹ was computed.

### (7) Manufacture of a Negative Electrode

The graphite particles, acetylene black (DENKI KAGAGU KOGYO KABUSHIKI KAISYA, HS-100) as an electrically conductive auxiliary material and poly(vinylidene fluoride) (KUREHA CORPORATION, KF polymer W#9300) as a binder were weighed in an amount of 8.00 g, 1.72 g and 4.30 g, respectively. After these were completely mixed, 9.32 g of N-methyl-2-pyrrolidone was added gradually, and kneading was performed with a defoaming kneader (NISSEI CORPORATION, NBK-1) to obtain paste. Note that when vapor grown carbon fibers were added to the paste, it is added before this kneading. This paste was applied on Cu foil with a thickness of 20 μm using a doctor blade with a clearance of 150 μm. The current collector to which the paste was applied was placed on a hot plate at about 80° C. to remove N-methyl-2-pyrrolidone. Then, it was dried in a vacuum dryer at 90° C. for 1 hour. After drying, pressure molding was performed by uniaxial press so that the electrode density calculated from the total mass and volume of the graphite particles and the binder became 1.50±0.05 g/cm³ to obtain a negative electrode. The resulting negative electrode was cutout in a size of φ15 mm. Then, the cut-out negative electrode was pressed for 10 seconds at 1.2 t/cm², and the mean thickness of the coating was measured to be 70 to 80 μm. Further, the loading level of the coating was 6.5 to 7.5 mg/cm².

### (8) Discharge Capacity and Initial Efficiency of the Battery

The negative electrode was introduced in a glove box filled with argon gas in which the dew point was controlled to be −75° C. or below. The negative electrode was placed in a coin cell (ROSEN CORPORATION CR2320), and an electrolytic solution (1M LiPF6 ethylene carbonate (EC): methylethyl carbonate (MEC)=40:60 [by volume ratio]) was allowed to permeate. On top of it, a separator (Celgard 2400) cutout in φ20 mm and a lithium foil cut out in φ17.5 mm with a thickness of 3 mm were placed in this order. A cap with a gasket was placed on top of it, and caulked with a caulking tool.

It was removed from the glove box, and allowed to keep at room temperature for 24 hours. Then, charging was performed at a constant current of 0.2 mA until 4.5 V was reached. Then charging was performed at a constant voltage of 4.5 V. When 0.2 mA was reached, the charging was stopped. Subsequently, discharging was performed at a constant current of 0.2 mA. When 2.5 V was reached, the discharge was stopped and paused for 10 minutes.

Based on the initial charging capacity and initial discharge capacity in this charge-discharge cycle, an initial efficiency was computed by the following formula.

$$( Initial efficiency ) = ( Initial discharge capacity ) / ( Initial charging capacity )$$

### (9) Cycle Characteristic of Battery

The following operations were performed inside a glove box in which a dry argon gas atmosphere with a dew point of −80° C. or below was maintained.

Ninety % by mass of positive electrode material (UNICORE, ternary positive electrode material Li(Ni, Mn, Co)O₂), 2% by mass of electrical conductivity imparting agent (TIMCAL, C45), 3% by mass of electrical conductivity imparting agent (TIMCAL, KS6L) and 5% by mass (solid content) of poly(vinylidene fluoride) (KUREHA CORPORATION, KF polymer W#1300) were mixed. Then, to this, N-methyl-2-pyrrolidone (KISHIDA CHEMICAL Co., Ltd.) was added, and kneaded to obtain paste. With an automatic coater, the paste was coated to an aluminum foil having a thickness of 20 μm using a doctor blade with a clearance of 200 μm, to produce a positive electrode.

In a lamination exterior case, the above negative electrode and the above positive electrode were layered via a polypropylene separator (TOKEN CHEMICAL CORPORATION, Celgard 2400). Next, electrolytic solution was poured in, and heat sealing was performed in vacuum to obtain a laminated cell for evaluation.

Using the above laminated cell, the following constant current and constant voltage charge and discharge tests were performed.

The initial and second charge-discharge cycles were performed as follows. Charging was performed at a constant current of 5.5 mA from the rest potential to 4.2 V, and then charging was performed at a constant voltage of 4.2 V. When a value of electric current decreased to 0.27 mA, the charging was stopped. Subsequently, discharge was performed at a constant current of 5.5 mA, and cut off at a voltage of 2.7 V.

Third and onward charge-discharge cycles were performed as follows. Charging was performed at a constant current of 5.5 mA (equivalent to 1 C) from the rest potential to 4.2 V, and then charging was performed at a constant voltage of 4.2 V. When a value of electric current decreased to 55 μA, the charging was stopped. Subsequently, discharge was performed at a constant current of 5.5 mA (equivalent to 1 C), and cut off at a voltage of 2.7 V. This charge-discharge cycle was repeated.

Then, the proportion of the 200th discharge capacity to the third discharge capacity was taken as a “cycle capacity retention” to perform evaluation.

### (10) High Rate Cycle Characteristic of Battery

The following operations were performed inside a glove box in which a dry argon gas atmosphere with a dew point of −80° C. or below was maintained.

Ninety % by mass of positive electrode material (UNICORE, ternary positive electrode material Li(Ni, Mn, Co) O₂), 2% by mass of electrical conductivity imparting agent (TIMCAL, C45), 3% by mass of electrical conductivity imparting agent (TIMCAL, KS6L) and 5% by mass (solid content) of poly(vinylidene fluoride) (KUREHA CORPORATION, KF polymer W#1300) were mixed. Then, to this, N-methyl-2-pyrrolidone (KISHIDA CHEMICAL CO., LTD.) was added, and kneaded to obtain paste. With an automatic coater, the paste was coated to an aluminum foil having a thickness of 20 μm using a doctor blade with a clearance of 200 μm to produce a positive electrode.

In a lamination exterior case, the above negative electrode and the above positive electrode were layered via a polypropylene separator (TONEN CHEMICAL CORPORATION, Celgard 2400). Next, electrolytic solution was poured in, and heat sealing was performed in vacuum to obtain a laminated cell for evaluation.

Using the above laminated cell, the following constant current and constant voltage charge and discharge tests were performed.

The initial and second charge-discharge cycles were performed as follows. Charging was performed at a constant current of 5.5 mA from the rest potential to 4.2 V, and then charging was performed at a constant voltage of 4.2 V. When a value of electric current decreased to 0.27 mA, the charging was stopped. Subsequently, discharge was performed at a constant current of 5.5 mA, and cut off at a voltage of 2.7 V.

Third and onward charge-discharge cycles were performed as follows. Charging was performed at a constant current of 16.5 mA (equivalent to 3 C) from the rest potential to 4.2 V, and then charging was performed at a constant voltage of 4.2 V. When a value of electric current decreased to 55 μA, the charging was stopped. Subsequently, discharge was performed at a constant current of 16.5 mA (equivalent to 3 C), and cut off at a voltage of 2.7 V. This charge-discharge cycle was repeated.

Then, the proportion of the 200th discharge capacity to the third discharge capacity was taken as a “high rate cycle capacity retention” to perform evaluation.

### (11) Input-Output Characteristic

Using the laminated cell produced as described above, input-output characteristic was evaluated by the following method.

First, discharge was performed at a constant current of 5.5 mA. Then, charging was performed at a constant current of 5.5 mA from the rest potential to 4.2 V, and then charging was performed at a constant voltage of 4.2 V. When a value of electric current decreased to 0.27 mA, the charging was stopped. Subsequently, discharge was performed at a constant current of 0.55 mA (equivalent to 0.1 C) for 2 hours. The value of voltage after the discharge was recorded.

Discharge was performed at a constant current of 1.1 mA (equivalent to 0.2 C) for 5 seconds, and paused for 30 minutes. Then, charging was performed at a constant current of 0.11 mA (equivalent to 0.02 C), and then charging was performed at a constant voltage of 4.2 V. The charge was stopped after 50 seconds, and the voltage was allowed to return to the level before the 5 second discharge.

The charge-discharge cycle in which 5 second constant current discharge at 1.1 mA (equivalent to 0.2 C), 30 minute pause and then 50 second constant current charging and constant voltage charging were performed under the conditions of constant current charging at 0.2 C, 0.5 C, 1 C and 2 C. Values of electric current and voltage at those times were recorded.

The above 5 second constant current discharge at 0.55 mA (equivalent to 0.1 C) was further performed for 3.5 hours, 5 hours, 6.5 hours, or 8 hours, and values of electric current and voltage at those times under the conditions of constant current charging of 0.2 C, 0.5 C, 1 C and 2C were recorded.

DC resistance was computed from those recorded values, and that value was taken as an “input-output characteristic” to perform evaluation. In a case where DC resistance is small, a decrease in input-output can be controlled, and a decrease in capacity also can be reduced, leading to high stability intended as designed.

### <<Lithium Ion Battery Having an Excellent Low Current Cycle Characteristic and an Excellent High Electric Current Cycle Characteristic>>

### Example 1

Petroleum based coke with HGI of 40 was ground to adjust the 50% particle diameter (D₅₀) to 15 μm. This was placed into an Atchison furnace, and heated at 3000° C. to obtain core material comprising graphite.

To this, powdered isotropic petroleum based pitch was dry-mixed in an amount to give 1% by mass relative to the core material, and heated at 1100° C. for 1 hour under an argon atmosphere to obtain composite graphite particles.

The resulting composite graphite particles showed 50% particle diameter of 15 μm, BET specific surface area of 1.2 m²/g, R value of 0.85, d₀₀₂ of 0.336 nm and I₁₁₀/I₀₀₄ of 0.46.

Further, the battery obtained using the above composite graphite particles showed initial discharge capacity of 331 mAh/g, initial efficiency of 92%, cycle capacity retention of 0.92, high rate cycle capacity retention of 0.88 and input-output characteristic of 4.8Ω.

### Example 2

Composite graphite particles were obtained by the same method as in Example 1 except that petroleum based coke with HGI of 50 was substituted for the petroleum based coke with HGI of 40.

The resulting composite graphite particles showed 50% particle diameter of 15 μm, BET specific surface area of 1.4 m²/g, R value of 0.77, d₀₀₂ of 0.337 nm and I₁₁₀/I₀₀₄ of 0.44.

Further, the battery obtained using the above composite graphite particles showed initial discharge capacity of 337 mAh/g, initial efficiency of 90% and cycle capacity retention of 0.93.

### Example 3

Composite graphite particles were obtained by the same method as in Example 1 except that an amount of the isotropic petroleum based pitch to be mixed with the core material comprising graphite was changed to 5% by mass relative to the core material.

The resulting composite graphite particles showed 50% particle diameter of 15 μm, BET specific surface area of 1.1 m²/g, R value of 0.91, d₀₀₂ of 0.338 nm and I₁₁₀/I₀₀₄ of 0.35.

Further, the battery obtained using the above composite graphite particles showed initial discharge capacity of 330 mAh/g, initial efficiency of 91% and cycle capacity retention of 0.94.

### Example 4

Composite graphite particles were obtained by the same method as in Example 1 except that the heating temperature in the Atchison furnace was changed to 2500° C.

The resulting composite graphite particles showed 50% particle diameter of 15 μm, BET specific surface area of 1.4 m²/g, R value of 0.87, d₀₀₂ of 0.340 nm and I₁₁₀/I₀₀₄ of 0.32.

Further, the battery obtained using the above composite graphite particles showed initial discharge capacity of 320 mAh/g, initial efficiency of 89% and cycle capacity retention of 0.90.

### Comparative Example 1

Petroleum based coke with HGI of 40 was ground to adjust 50% particle diameter (D₅₀) to 15 μm. This was placed into an Atchison furnace, and heated at 3000° C. to obtain graphite particles.

The resulting graphite particles showed 50% particle diameter of 15 μm, BET specific surface area of 1.6 m²/g, R value of 0.08, d₀₀₂ of 0.335 nm and I₁₁₀/I₀₀₄ of 0.59.

Further, the battery obtained by using the above composite graphite particles showed initial discharge capacity of 333 mAh/g, initial efficiency of 90% and cycle capacity retention of 0.80.

### Comparative Example 2

Graphite particles were obtained by the same method as in Comparative Example 1 except that petroleum based coke with HGI of 50 was substituted for the petroleum based coke with HGI of 40.

The resulting graphite particles showed 50% particle diameter of 15 μm, BET specific surface area of 1.8 m²/g, R value of 0.06, d₀₀₂ of 0.335 nm and I₁₁₀/I₀₀₄ of 0.57.

Further, the battery obtained using the above composite graphite particles showed initial discharge capacity of 336 mAh/g, initial efficiency of 89% and cycle capacity retention of 0.82.

### Comparative Example 3

Composite graphite particles were obtained by the same method as in Example 1 except that the heating temperature in the Atchison furnace was changed to 2000° C.

The resulting composite graphite particles showed 50% particle diameter of 15 μm, BET specific surface area of 1.6 m²/g, R value of 0.96, d₀₀₂ of 0.349 nm and I₁₁₀/I₀₀₄ of 0.25.

Further, the battery obtained using the above composite graphite particles showed initial discharge capacity of 299 mAh/g, initial efficiency of 82% and cycle capacity retention of 0.82.

### Comparative Example 4

Composite graphite particles were obtained by the same method as in Example 1 except that petroleum based coke with HGI of 30 was substituted for the petroleum based coke with HGI of 40.

The resulting composite graphite particles showed 50% particle diameter of 15 μm, BET specific surface area of 1.5 m²/g, R value of 0.87, d₀₀₂ of 0.335 nm and I₁₁₀/I₀₀₄ of 0.41.

Further, the battery obtained using the above composite graphite particles showed initial discharge capacity of 326 mAh/g, initial efficiency of 85% and cycle capacity retention of 0.85.

### Comparative Example 5

Composite graphite particles were obtained by the same method as in Example 1 except that petroleum based coke with HGI of 70 was substituted for the petroleum based coke with HGI of 40.

The resulting composite graphite particles showed 50% particle diameter of 18 μm, BET specific surface area of 3.1 m²/g, R value of 0.62, d₀₀₂ of 0.336 nm and I₁₁₀/I₀₀₄ of 0.57.

Further, the battery obtained using the above composite graphite particles showed initial discharge capacity of 356 mAh/g, initial efficiency of 80% and cycle capacity retention of 0.61.

These results are shown together in Tables 1 and 2. Note that the results from Example 5 are also shown together for reference. Tables 1 and 2 show that a battery has good low current cycle characteristic, the battery comprising a negative electrode obtained by using composite graphite particles, the composite graphite particles comprising core material comprising graphite obtained by heat treating petroleum based coke with a grindability index of 35 to 60 at 2500° C. or higher and carbonaceous layer present on the surface of the core material, wherein the composite graphite particles have an intensity ratio I_{D}/I_{G} of intensity (I_{D}) of peak in the range between 1300 and 1400 cm⁻¹ and intensity (I_{G}) of peak in the range between 1500 and 1620 cm⁻¹ as measured by a Raman spectroscopy spectrum of not less than 0.1, and 50% particle diameter (D₅₀) in accumulated particle size distribution by volume as measured by the laser diffraction method of not less than 10 μm and not more than 30 μm, as well as a molded product having a density of 1.35 to 1.45 g/cm³ obtained by pressure molding the composite graphite particles with binder has a ratio I¹¹⁰/I₀₀₄ of an intensity of 110 diffraction peak (I₁₁₀) and an intensity of 004 diffraction peak (I₀₀₄) as measured by the X ray wide angle diffraction method of 0.2 or more. A lithium ion battery having an excellent low current cycle characteristic is suitable as a power supply for electric-powered automobile or the like.

TABLE 1

| | | | Heat | | Mean | | |
|---|---|---|---|---|---|---|---|
| | | Grind- | treatment | Coating | particle | | |
| | | ability | temp. | amount | diameter | d₀₀₂ | I₁₁₀/ |
| | | index | [° C.] | [wt %] | [μm] | [nm] | I₀₀₄ |
| Example | 1 | 40 | 3000 | 1 | 15 | 0.336 | 0.46 |
| | 2 | 50 | 3000 | 1 | 15 | 0.337 | 0.44 |
| | 3 | 40 | 3000 | 5 | 15 | 0.338 | 0.35 |
| | 4 | 40 | 2500 | 1 | 15 | 0.340 | 0.32 |
| | 5 | 40 | 3000 | 1 | 6 | 0.336 | 0.44 |
| Comp. Ex. | 1 | 40 | 3000 | 0 | 15 | 0.335 | 0.59 |
| | 2 | 50 | 3000 | 0 | 15 | 0.335 | 0.57 |
| | 3 | 40 | 2000 | 1 | 15 | 0.349 | 0.25 |
| | 4 | 30 | 3000 | 1 | 15 | 0.335 | 0.41 |
| | 5 | 70 | 3000 | 1 | 18 | 0.336 | 0.57 |

TABLE 2

| | | Specific | | Initial | | |
|---|---|---|---|---|---|---|
| | | surface | | discharge | Initial | Cycle |
| | | area | | capacity | efficiency | capacity |
| | | [m²/g] | R value | [mAh/g] | [%] | retention |
| Example | 1 | 1.2 | 0.85 | 331 | 92 | 0.92 |
| | 2 | 1.4 | 0.77 | 337 | 90 | 0.93 |
| | 3 | 1.1 | 0.91 | 330 | 91 | 0.94 |
| | 4 | 1.4 | 0.87 | 320 | 89 | 0.90 |
| | 5 | 2.3 | 0.85 | 330 | 92 | 0.85 |
| Comp. Ex. | 1 | 1.6 | 0.08 | 333 | 90 | 0.80 |
| | 2 | 1.8 | 0.06 | 336 | 89 | 0.82 |
| | 3 | 1.6 | 0.96 | 299 | 82 | 0.82 |
| | 4 | 1.5 | 0.87 | 326 | 85 | 0.85 |
| | 5 | 3.1 | 0.62 | 356 | 80 | 0.61 |

### <<Lithium Ion Battery Having an Excellent Input-Output Characteristic and an Excellent High Current Cycle Characteristic>>

### Example 5

Petroleum based coke with HGI of 40 was ground to adjust 50% particle diameter (D₅₀) to 6 μm. This was placed into an Atchison furnace, and heated at 3000° C. to obtain core material comprising graphite.

To this, powdered isotropic petroleum based pitch was dry-mixed in an amount to give 1% by mass relative to the core material, and heated at 1100° C. for 1 hour under an argon atmosphere to obtain composite graphite particles.

The resulting composite graphite particles showed 50% particle diameter of 6 μm, BET specific surface area of 2.3 m²/g, R value of 0.85, d₀₀₂ of 0.336 nm and I₁₁₀/I₀₀₄ of 0.44.

Further, the battery obtained using the above composite graphite particles showed initial discharge capacity of 330 mAh/g, initial efficiency of 92%, high rate cycle capacity retention of 0.82, input-output characteristic of 3.8Ω and cycle capacity retention of 0.85.

### Example 6

Composite graphite particles were obtained by the same method as in example 5 except that petroleum based coke with HGI of 50 was substituted for the petroleum based coke with HGI of 40.

The resulting composite graphite particles showed 50% particle diameter of 6 μm, BET specific surface area of 2.7 m²/g, R value of 0.77, d₀₀₂ of 0.337 nm and I₁₁₀/I₀₀₄, of 0.42.

Further, the battery obtained using the above composite graphite particles showed initial discharge capacity of 335 mAh/g, initial efficiency of 90%, high rate cycle capacity retention of 0.83 and input-output characteristic of 3.7Ω.

### Example 7

Composite graphite particles were obtained by the same method as in Example 5 except that an amount of the isotropic petroleum based pitch to be mixed with the core material comprising graphite was changed to 5% by mass relative to the core material.

The resulting composite graphite particles showed 50% particle diameter of 6 μm, BET specific surface area of 2.1 m²/g, R value of 0.91, d₀₀₂ of 0.338 nm and I₁₁₀/I₀₀₄ of 0.32.

Further, the battery obtained using the above composite graphite particles showed initial discharge capacity of 328 mAh/g, initial efficiency of 91%, high rate cycle capacity retention of 0.85 and input-output characteristic of 3.6Ω.

### Example 8

Composite graphite particles were obtained by the same method as in Example 5 except that the heating temperature in the Atchison furnace was changed to 2500° C.

The resulting composite graphite particles showed 50% particle diameter of 6 μm, BET specific surface area of 2.6 m²/g, R value of 0.86, d₀₀₂ of 0.340 nm and I₁₁₀/I₀₀₄ of 0.35.

Further, the battery obtained using the above composite graphite particles showed initial discharge capacity of 318 mAh/g, initial efficiency of 88%, high rate cycle capacity retention of 0.80 and input-output characteristic of 4.0Ω.

### Comparative Example 6

Petroleum based coke with HGI of 40 was ground to adjust the 50% particle diameter (D50) to 6 μm. This was placed into an Atchison furnace, and heated at 3000° C. to obtain graphite particles.

The resulting graphite particles showed 50% particle diameter of 6 μm, BET specific surface area of 3.0 m²/g, R value of 0.08, d₀₀₂ of 0.335 nm and I₁₁₀/I₀₀₄ of 0.56.

Further, the battery obtained using the above composite graphite particles showed initial discharge capacity of 331 mAh/g, initial efficiency of 90%, high rate cycle capacity retention of 0.61 and input-output characteristic of 5.3Ω.

### Comparative Example 7

Graphite particles were obtained by the same method as in Comparative Example 6 except that petroleum based coke with HGI of 50 was substituted for the petroleum based coke with HGI of 40.

The resulting graphite particles showed 50% particle diameter of 6 μm, BET specific surface area of 3.5 m²/g, R value of 0.06, d₀₀₂ of 0.335 nm and I₁₁₀/I₀₀₄ of 0.51.

Further, the battery obtained using the above composite graphite particles showed initial discharge capacity of 334 mAh/g, initial efficiency of 89%, high rate cycle capacity retention of 0.58 and input-output characteristic of 5.2Ω.

### Comparative Example 8

Composite graphite particles were obtained by the same method as in Example 5 except that the heating temperature in the Atchison furnace was changed to 2000° C.

The resulting composite graphite particles showed 50% particle diameter of 6 μm, BET specific surface area of 2.5 m²/g, R value of 0.96, d₀₀₂ of 0.349 nm and I₁₁₀/I₀₀₄ of 0.21.

Further, the battery obtained using the above composite graphite particles showed initial discharge capacity of 295 mAh/g, initial efficiency of 82%, high rate cycle capacity retention of 0.75 and input-output characteristic of 3.2ψ.

### Comparative Example 9

Composite graphite particles were obtained by the same method as in Example 5 except that petroleum based coke with HGI of 30 was substituted for the petroleum based coke with HGI of 40.

The resulting composite graphite particles showed 50% particle diameter of 6 μm, BET specific surface area of 2.1 m²/g, R value of 0.87, d₀₀₂ of 0.335 nm and I₁₁₀/I₀₀₄ of 0.38.

Further, the battery obtained using the above composite graphite particles showed initial discharge capacity of 325 mAh/g, initial efficiency of 85%, high rate cycle capacity retention of 0.74 and input-output characteristic of 5.0Ω.

### Comparative Example 10

Composite graphite particles were obtained by the same method as in Example 5 except that petroleum based coke with HGI of 40 was substituted for the petroleum based coke with HGI of 70, and the 50% particle diameter was adjusted to 18 μm by grinding.

The resulting composite graphite particles showed 50% particle diameter of 7 μm, BET specific surface area of 5.5 m²/g, R value of 0.62, d₀₀₂ of 0.336 nm and I₁₁₀/I₀₀₄ of 0.53.

Further, the battery obtained using the above composite graphite particles showed initial discharge capacity of 345 mAh/g, initial efficiency of 80%, high rate cycle capacity retention of 0.52 and input-output characteristic of 5.5Ω.

These results are shown together in Tables 3 and 4. Note that the results from Example 1 are also shown together for reference. Tables 3 and 4 show that a battery has good input-output characteristic and high current cycle characteristic, the battery comprising a negative electrode obtained by using composite graphite particles, the composite graphite particles comprising core material comprising graphite obtained by heat treating petroleum based coke with a grindability index of 35 to 60 at 2500° C. or higher and carbonaceous layer present on the surface of the core material, wherein the composite graphite particles have an intensity ratio I_{D}/I_{G} of intensity (I_{D}) of peak in the range between 1300 and 1400 cm⁻¹ and intensity (I_{G}) of peak in the range between 1500 and 1620 cm⁻¹ as measured by a Raman spectroscopy spectrum of 0.1 or more, and 50% particle diameter (D₅₀) in accumulated particle size distribution by volume as measured by the laser diffraction method of not less than 3 μm and less than 10 μm, as well as a molded product having a density of 1.35 to 1.45 g/cm³ obtained by pressure molding the composite graphite particles with binder has a ratio I₁₁₀/I₀₀₄ of an intensity of 110 diffraction peak (I₁₁₀) and an intensity of 004 diffraction peak (I₀₀₄) as measured by the X ray wide angle diffraction method of 0.2 or more. A lithium ion battery being excellent in input-output characteristic and high current cycle characteristic is suitable as a power supply for a hybrid automobile having an engine and a motor or the like.

TABLE 3

| | | | Heat | | Mean | | |
|---|---|---|---|---|---|---|---|
| | | Grind- | treatment | Coating | particle | | |
| | | ability | temp. | amount | diameter | d₀₀₂ | I₁₁₀/ |
| | | index | [° C.] | [wt %] | [μm] | [nm] | I₀₀₄ |
| Example | 5 | 40 | 3000 | 1 | 6 | 0.336 | 0.44 |
| | 6 | 50 | 3000 | 1 | 6 | 0.337 | 0.42 |
| | 7 | 40 | 3000 | 5 | 6 | 0.338 | 0.32 |
| | 8 | 40 | 2500 | 1 | 6 | 0.340 | 0.35 |
| | 1 | 40 | 3000 | 1 | 15 | 0.336 | 0.46 |
| Comp. Ex. | 6 | 40 | 3000 | 0 | 6 | 0.335 | 0.56 |
| | 7 | 50 | 3000 | 0 | 6 | 0.335 | 0.51 |
| | 8 | 40 | 2000 | 1 | 6 | 0.349 | 0.21 |
| | 9 | 30 | 3000 | 1 | 6 | 0.335 | 0.38 |
| | 10 | 70 | 3000 | 1 | 7 | 0.336 | 0.53 |

TABLE 4

| | | | | Initial | | High rate | |
|---|---|---|---|---|---|---|---|
| | | Specific | | discharge | Initial | cycle | Output-Input |
| | | surface | | capacity | efficiency | capacity | Characteristc |
| | | area [m²/g] | R value | [mAh/g] | [%] | retention | [Ω] |
| Example | 5 | 2.3 | 0.85 | 330 | 92 | 0.82 | 3.8 |
| | 6 | 2.7 | 0.77 | 335 | 90 | 0.83 | 3.7 |
| | 7 | 2.1 | 0.91 | 328 | 91 | 0.85 | 3.6 |
| | 8 | 2.6 | 0.86 | 318 | 88 | 0.80 | 4.0 |
| | 1 | 1.2 | 0.85 | 331 | 92 | 0.88 | 4.8 |
| Comp. Ex. | 6 | 3.0 | 0.08 | 331 | 90 | 0.61 | 5.3 |
| | 7 | 3.5 | 0.06 | 334 | 89 | 0.58 | 5.2 |
| | 8 | 2.5 | 0.96 | 295 | 82 | 0.75 | 3.2 |
| | 9 | 2.1 | 0.87 | 325 | 85 | 0.74 | 5.0 |
| | 10 | 5.5 | 0.62 | 345 | 80 | 0.52 | 5.5 |

1.-14. (canceled)

15. Composite graphite particles comprising
core material comprising graphite obtained by heat treating petroleum based coke with a grindability index of 35 to 60 at a temperature of not less than 2500° C. and not more than 3500° C. and
carbonaceous layer present on the surface of the core material,
wherein the composite graphite particles have an intensity ratio I_{D}/I_{G} of 0.1 or more in intensity (I_{D}) of peak in the range between 1300 and 1400 cm⁻¹ and intensity (I_{G}) of peak in the range between 1500 and 1620 cm⁻¹ as measured by Raman spectroscopy spectrum,
the composite graphite particles have a 50% particle diameter (D₅₀) of not less than 3 μm and not more than 30 μm in accumulated particle size distribution by volume as measured by the laser diffraction method, and
the composite graphite particles have a ratio I₁₁₀/I₀₀₄ of 0.2 or more in an intensity of 110 diffraction peak (I₁₁₀) and an intensity of 004 diffraction peak (I₀₀₄) as measured by the X ray wide angle diffraction method when the composite graphite particles and a binder was molded with pressure to adjust the density of 1.35 to 1.45 g/cm³.

16. The composite graphite particles according to claim 15, wherein d₀₀₂ based on 002 diffraction peak as measured by the X ray wide angle diffraction method is not less than 0.334 nm and not more than 0.342 nm.

17. The composite graphite particles according to claim 15, wherein a BET specific surface area based on nitrogen adsorption is 0.2 to 30 m²/g.

18. The composite graphite particles according to claim 15, wherein an amount of the carbonaceous layer is 0.05 to 10 parts by mass relative to 100 parts by mass of the core material.

19. The composite graphite particles according to claim 15, wherein the carbonaceous layer is obtained by heat treating organic compound at a temperature of 500° C. or higher.

20. The composite graphite particles according to claim 19, wherein the organic compound is at least one compound selected from the group consisting of petroleum based pitch, coal based pitch, phenol resin, polyvinyl alcohol resin, furan resin, cellulose resin, polystyrene resin, polyimide resin and epoxy resin.

21. The composite graphite particles according to claim 15, wherein the 50% particle diameter (D₅₀) in accumulated particle size distribution by volume as measured by the laser diffraction method is not less than 3 μm and less than 10 μm.

22. The composite graphite particles according to claim 15, wherein the 50% particle diameter (D₅₀) in accumulated particle size distribution by volume as measured by the laser diffraction method is not less than 10 μm and not more than 30 μm.

23. A method of manufacturing the composite graphite particles according to claim 15, the method comprising:
heat treating petroleum based coke having a grindability index of 35 to 60 at a temperature of not less than 2500° C. and not more than 3500° C. to obtain core material comprising graphite,
allowing organic compound to adhere with the core material comprising graphite, and then
heat treating at a temperature of 500° C. or higher.

24. A slurry or a paste comprising the composite graphite particles according to claim 15, binder and solvent.

25. The slurry or the paste according to claim 24, further comprising natural graphite.

26. An electrode sheet comprising a laminated layer having a current collector and an electrode layer comprising the composite graphite particles according to claim 15.

27. The electrode sheet according to claim 26, wherein the electrode layer further comprises natural graphite, and
the electrode sheet has a ratio I₁₁₀/I₀₀₄ of not less than 0.1 and not more than 0.15 in an intensity of 110 diffraction peak (I₁₁₀) and an intensity of 004 diffraction peak (I₀₀₄) as measured by the X ray wide angle diffraction method.

28. A lithium ion battery comprising a negative electrode, in which the negative electrode comprises the electrode sheet according to claim 26.
